(19) United States
(12) Patent Application Publication
(10) Pub. No.: US 2026/0300004 A1
(43) Pub. Date: Oct. 1, 2026

(54) INFORMATION PROCESSING DEVICE

(71) Applicant: TOYOTA JIDOSHA KABUSHIKI KAISHA, Toyota-shi (JP)

(72) Inventors: Aya Yamada Kamisaka, Tokyo (JP); Takayuki Yamabe, Tokyo (JP); Kota Hoshiba, Tokyo (JP); Ryota Nakanishi, Tokyo (JP); Hajime Tojiki, Tokyo (JP)

(73) Assignee: TOYOTA JIDOSHA KABUSHIKI KAISHA, Toyota-shi (JP)

(21) Appl. No.: 19/541,722

(22) Filed: Feb. 17, 2026

(30) Foreign Application Priority Data
Mar. 26, 2025 (JP) 2025-052101

(51) Int. Cl. G06F 9/48; G06Q 10/0631; G06Q 10/109

(52) U.S. Cl. CPC G06F 9/4881; G06Q 10/06312; G06Q 10/109

(57) ABSTRACT

An information processing device according to the present disclosure includes a control unit. The control unit is configured to: acquire schedule information indicating a plan of a user from a scheduler; decompose the plan indicated by the acquired schedule information into one or more tasks; estimate the respective processing times to perform the one or more tasks according to the processing ability of the user for each task, the processing ability being given in advance; predict free time of the user in the future based on the estimated respective processing times of the one or more tasks; and output information related to the predicted free time.

### CROSS-REFERENCE TO RELATED APPLICATION

This application claims priority to Japanese Patent Application No. 2025-052101 filed on Mar. 26, 2025. The disclosure of the above-identified application, including the specification, drawings, and claims, is incorporated by reference herein in its entirety.

### BACKGROUND

### 1. Technical Field

The present disclosure relates to information processing devices.

### 2. Description of Related Art

Japanese Unexamined Patent Application Publication No. 2006-146530 (JP 2006-146530 A) proposes a scheduling support system that generates and decomposes tasks and assigns them to available time slots.

### SUMMARY

One object of the present disclosure is to provide a technique for predicting whether a free time slot in a scheduler is actually available.

An information processing device according to the present disclosure includes a control unit. The control unit is configured to: acquire schedule information indicating a plan of a user from a scheduler; decompose the plan indicated by the acquired schedule information into one or more tasks; estimate respective processing times to perform the one or more tasks according to processing ability of the user for each task, the processing ability being given in advance; predict free time of the user in the future based on the estimated respective processing times of the one or more tasks; and output information related to the predicted free time.

The present disclosure makes it possible to predict whether a free time slot in a scheduler is actually available.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a situation in which the present disclosure is applied;

FIG. 2 schematically shows an example of a situation in which the processing time of a task is estimated using a machine learning model;

FIG. 3A schematically shows an example of a situation in which free time is predicted based on the estimated processing times of one or more tasks;

FIG. 3B schematically shows an example of a situation in which free time is predicted based on the estimated processing times of one or more tasks;

FIG. 4 schematically shows an example of the hardware configuration of an information processing device;

FIG. 5 is a flowchart showing an example of the processing procedure for training a machine learning model; and

FIG. 6 is a flowchart showing an example of a processing procedure executed by the information processing device.

### DETAILED DESCRIPTION OF EMBODIMENTS

For example, a conventional system such as that disclosed in JP 2006-146530 A decomposes tasks included in a task list into subtasks, allocates working time to each decomposed subtask, and prepares a work plan. This reduces the burden of schedule management. However, the inventors have found that such conventional systems have the following issue. That is, conventional systems set tasks on the premise that time periods with no scheduled events in the scheduler represent free time. However, even time periods with no events scheduled in the scheduler may not in fact be free time, for example, because the user has not registered a task or because the processing time of the preceding task has been extended.

In contrast, the information processing device according to the present disclosure includes a control unit. The control unit is configured to: acquire schedule information indicating a plan of a user from a scheduler; decompose the plan indicated by the acquired schedule information into one or more tasks; estimate the respective processing times to perform the one or more tasks according to the processing ability of the user for each task, the processing ability being given in advance; predict free time of the user in the future based on the estimated respective processing times of the one or more tasks; and output information related to the predicted free time. With this configuration, it is possible to predict whether a free time slot in the scheduler is actually available by estimating the processing times of tasks based on the user's processing ability given in advance. This makes it possible to more accurately keep track of the plans registered in the scheduler. For example, it becomes more likely that a new plan can be registered without overlapping with existing plans.

As another aspect of the information processing device of the above aspect, the present disclosure may also be implemented as an information processing method that realizes all or part of the foregoing components, as a program, or as a machine-readable storage medium, such as a computer-readable storage medium, in which such a program is stored. The "machine-readable storage medium such as a computer-readable storage medium" refers to a medium that stores information such as a program by electrical, magnetic, optical, mechanical, or chemical action.

### 1. Application Example

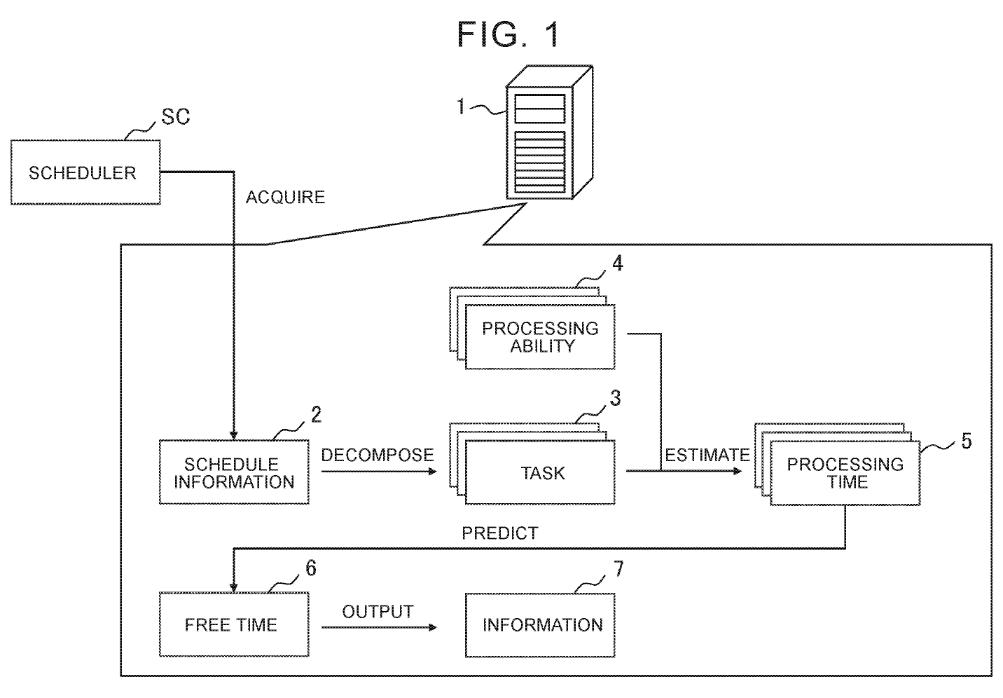

FIG. 1 schematically shows an example of a situation in which the present disclosure is applied. First, the information processing device 1 acquires schedule information 2 indicating a user's plans from a scheduler SC and decomposes each plan indicated by the acquired schedule information 2 into one or more tasks 3. After decomposing the plan into one or more tasks 3, the information processing device 1 estimates the respective processing times 5 to perform the one or more tasks 3 according to the processing ability 4 for each task 3. The processing ability 4 for each task is given in advance. The information processing device 1 predicts free time 6 based on the estimated respective processing times 5 of the one or more tasks 3. The information processing device 1 then outputs information 7 related to the predicted free time 6.

### Scheduler

The scheduler SC may be an application for managing a user's plans. The type of scheduler SC is not particularly limited as long as it can acquire information on a user's plans, and may be selected as appropriate according to the embodiment. In one example, the scheduler SC may be configured to acquire schedule information 2 indicating a user's plans. The user's plans may include any kind of plans, including both business and personal plans.

### Schedule Information

The configuration of the schedule information 2 is not particularly limited as long as it indicates the user's plans, and may be determined as appropriate according to the embodiment. For example, the schedule information 2 may include attributes such as the name, type, description, and time of each plan. The name may be specified in free-form natural language. The type may be defined as appropriate according to the embodiment, for example, as a meeting, travel, shopping, or meal. The description may include information indicating details of the plan, such as the location and the people involved. The time may include information that can specify the scheduled start and end times of the plan (for example, a combination of a start time and an end time, a combination of a start time and scheduled duration, or the date of the plan).

### Task Decomposition

The method for decomposing a user's plan into one or more tasks 3 is not particularly limited and may be selected as appropriate according to the embodiment. In one example, the user's plan may be decomposed into one or more tasks 3 in a rule-based manner based on the attributes of the plan indicated in the schedule information 2. For example, when the type of plan is travel, the plan may be decomposed into walking and train travel. The rules for decomposing a plan into tasks 3 may be defined as appropriate according to the embodiment. In another example, a trained machine learning model such as a large-scale generative model may be used to decompose the plan into tasks 3. The large-scale generative model may include a large language model, a large vision-language model, or a large speech

model. A known method, such as that disclosed in JP 2006-146530 A, may also be adopted as the method for decomposing a plan into tasks 3.

### Estimation of Task Processing Times

The information processing device 1 may estimate the processing time 5 to perform each task 3 according to the processing ability 4 of the user given in advance.

In one example, the respective processing times 5 to perform the one or more tasks 3 may be estimated according to the processing ability 4 of the user for each task 3. The processing ability 4 may be given in advance for each task 3. For example, the processing ability 4 for each task 3 may be given in advance based on statistical values of the user's processing times for past tasks. The processing times for the past tasks may be collected as appropriate. The statistical values may include, for example, an average value or a weighted average value. In this case, estimating the respective processing times 5 to perform the one or more tasks 3 according to the processing ability 4 for each task 3 may be achieved by estimating the processing times 5 based on statistical values of the processing times that are given in advance for each task 3. For example, when the amount of work of a task is variable, such as walking or train travel, the statistical values may be calculated as indicators of the processing time per unit amount of work of the task (for example, 15 minutes per kilometer walked). In this case, the processing time 5 of a task 3 may be calculated as the product of the statistical value and the amount of work of the task 3. For example, when the amount of work of a task is constant, the statistical value may be directly used as the processing time 5 of the task 3.

In another example, estimating the respective processing times 5 to perform the one or more tasks 3 according to the processing ability 4 for each task 3 may be achieved by estimating the respective processing times 5 to perform the one or more tasks 3 by using a trained machine learning model LM that has acquired the ability to estimate the processing time of a task based on the user's past task performance.

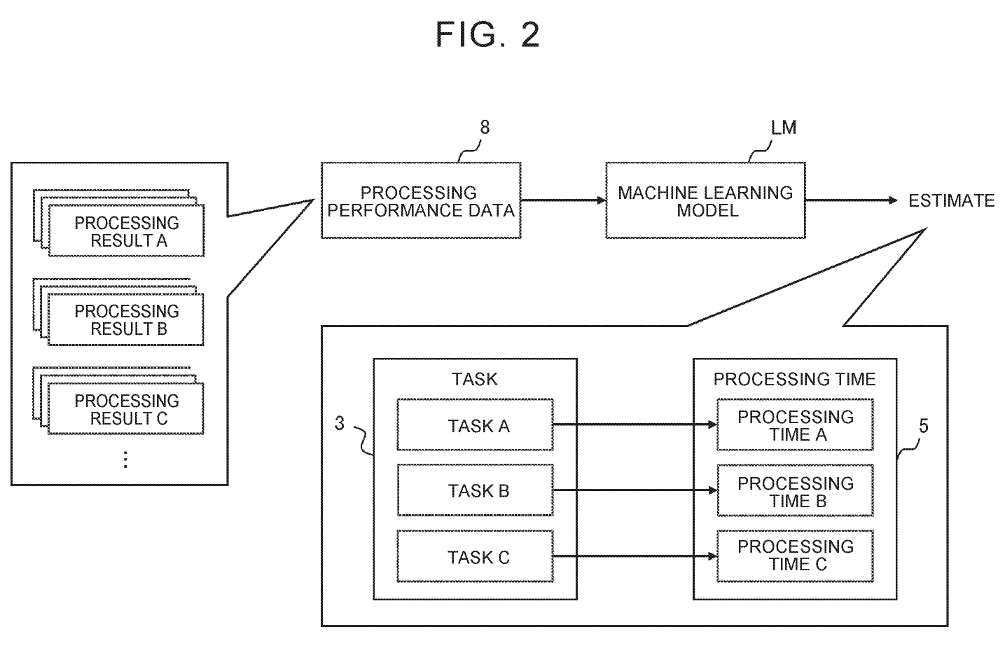

FIG. 2 schematically shows an example of a situation in which the processing time 5 of a task 3 is estimated using the machine learning model LM. The machine learning model LM is configured to estimate the processing time 5 from a given input (such as a task 3). In the example shown in FIG. 2, processing performance data 8 (processing results A to C) are accumulated for each task 3 (tasks A to C). The machine learning model LM is trained to estimate the processing time 5 (processing times A to C) based on the processing performance data 8. The configuration of the machine learning model LM is not particularly limited as long as it can perform such estimation processing, and may be selected as appropriate according to the embodiment. The machine learning model LM may be implemented using any type of machine learning model.

The machine learning model LM is configured to include one or more computational parameters that can be adjusted through machine learning. The one or more computational parameters are used in calculations for the intended inference (the estimation of the processing time 5). The machine learning model LM may be implemented using, for example, a neural network, a regression model, a decision tree model, a support vector machine, or other mathematical function (computational model). The machine learning method may be selected as appropriate according to the type of machine learning model adopted. Examples of machine learning methods include known optimization techniques such as the error backpropagation method, regression analysis (e.g., multiple regression analysis), and random forest.

Records of the user's past task performance may be accumulated as processing performance data 8 and used for training the machine learning model LM. The content of the processing performance data 8 is not particularly limited and may be determined as appropriate according to the embodiment. In one example, the processing performance data 8 may be stored as a history of processing results (processing times) for each task. In other words, the processing performance data 8 may include a plurality of datasets, each including a task (input sample) and its processing time (correct label).

Machine learning is to adjust (optimize) the values of computational parameters using training samples (processing performance data 8). In one example, the information processing device 1 may perform, as a machine learning process, supervised learning using a plurality of datasets of the processing performance data 8. Each dataset may include a task (input sample) and its processing time (correct label). In supervised learning, the values of the computational parameters of the machine learning model LM may be adjusted (optimized) such that the output obtained from the machine learning model LM in response to a given training sample (processing performance data 8) matches the corresponding correct label. However, the machine learning method is not limited to this example and may be modified as appropriate according to the embodiment.

The training of the machine learning model LM may be performed by a computer other than the information processing device 1. The information processing device 1 may acquire the values of the adjusted computational parameters from another computer, and use the values of the acquired computational parameters as the parameters of the machine learning model LM.

### Prediction of Free Time

By summing the estimated processing times 5 of one or more tasks 3, the processing time (total processing time) actually taken for the target plan can be determined. Using this total processing time, the information processing device 1 may predict the user's future free time 6 as appropriate based on the estimated processing times 5 of the one or more tasks 3. In one example, when predicting the free time 6, the information processing device 1 may set a reference time for the plan. The information processing device 1 may predict the free time 6 by assuming that the one or more tasks 3 are performed during the time before and/or after the set reference time. The reference time may be set to any point in time within the scheduled time period (start time to end time). In a typical example, the reference time may be the scheduled start time or end time of the plan. When the schedule information 2 includes the start time or the end time, either the start time or the end time, whichever is included in the schedule information 2, may be selected as the reference time.

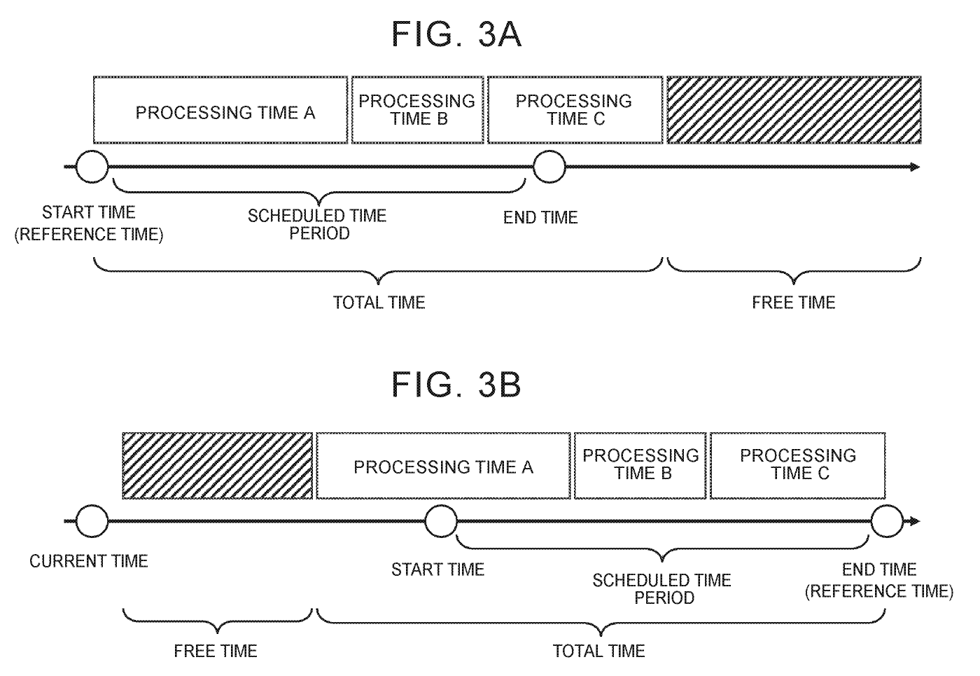

FIGS. 3A and 3B schematically show examples of a situation in which the free time 6 is predicted based on the estimated processing times 5 of one or more tasks 3. As shown in FIGS. 3A and 3B, it is assumed that the plan is decomposed into three tasks 3 (tasks A, B, and C) and that the respective processing times 5 (processing times A, B, and C) for the three tasks 3 has been estimated. The schedule information 2 includes the scheduled time period (start time and end time).

In one example, when there is no other plan after the scheduled time period, the information processing device 1 may determine that the one or more tasks 3 are to be performed during the time period after the reference time. In other words, predicting the user's future free time 6 may be achieved by predicting, as the free time 6, the time after the total of the estimated processing times 5 of the one or more tasks 3 has elapsed from the reference time of the plan. In the example of FIG. 3A, the reference time is set to the scheduled start time of the plan, and the time after the total of the processing times A to C has elapsed from the start time is regarded as the free time 6. In the example of FIG. 3A, the point in time when the total of the processing times A to C has elapsed from the scheduled start time of the plan corresponds to a time after the expected end time. In this case, in conventional systems, the time after the end time is regarded as the free time 6. As a result, the processing time C (that is, the period from the scheduled end time of the plan to the end time of the processing time C) is regarded as the free time 6. On the other hand, with this configuration, the information processing device 1 predicts the time after the end time of the processing time C as the free time 6, and can therefore reduce the possibility of regarding the time during which the task 3 (task C) is being processed as the free time 6.

In another example, when there is no other plan before the scheduled time period, the information processing device 1 may determine that the one or more tasks 3 are to be performed during the time period before the reference time. In other words, predicting the user's future free time 6 may be achieved by predicting, as the free time 6, the time between the current time and the point in time calculated by going back from the reference time of the plan by the total of the estimated processing times 5 of the one or more tasks 3. In the example of FIG. 3B, the reference time is set to the scheduled end time of the plan, and the time between the current time and the point in time calculated by going back from the end time by the total of the processing times A to C is regarded as the free time 6. In the example of FIG. 3B, the point in time calculated by going back from the scheduled end time of the plan by the total of the processing times A to C corresponds to a time before the expected start time. In this case, in conventional systems, the time before the scheduled start time is regarded as the free time 6. As a result, the processing time A (that is, the period from the start time of the processing time A to the scheduled start time of the plan) is regarded as the free time 6. On the other hand, with this configuration, the information processing device 1 predicts the time before the start time of the processing time A as the free time 6, and can therefore reduce the possibility of regarding the time during which the task 3 (task A) is being processed as the free time 6.

The time period during which the one or more tasks 3 are to be performed with respect to the reference time is not limited to the examples shown in FIGS. 3A and 3B, and may be determined as appropriate. In one example, it may be determined that some of the tasks 3 are to be performed before the reference time and the remaining tasks 3 are to be performed after the reference time. In this case, predicting the user's future free time 6 may be achieved by predicting, as the free time 6, the time after the current time and other than the time periods during which the one or more tasks 3 are performed.

In one example, the time periods during which the one or more tasks 3 are to be performed may be determined according to the amount of time by which the total of the processing times 5 of the one or more tasks 3 exceeds the scheduled time period (hereinafter referred to as "excess time"). For example, the time period between the point in time calculated by going back from the scheduled start time of the plan by an amount of time equal to or shorter than the excess time, and the point in time after the remaining time (i.e., the excess time minus the amount of time counted back) has elapsed from the scheduled end time of the plan may be regarded as the time period during which the one or more tasks 3 are performed. Typically, the amount of time counted back may be set to half of the excess time.

In another example, the time periods during which the one or more tasks 3 are to be performed may be determined according to the types of the tasks 3. For example, when a task 3 is a task to be performed before the plan (hereinafter referred to as "preparatory task"), the time periods may be determined such that the preparatory task is completed before the scheduled start time of the plan. When a task 3 is a task to be performed during the plan (hereinafter referred to as "execution task"), the time periods may be determined such that the execution task is started after the scheduled start time of the plan. The type of each task 3 (whether it is a preparatory task or an execution task) may be defined in advance.

### Output of Information Related to Free Time

In a typical example, outputting the information 7 related to the result of predicting the free time 6 may be achieved by directly outputting the predicted free time 6 itself. However, as long as the information 7 relates to the result of predicting the free time 6, the content of the information 7 to be output is not limited to such an example and may be determined as appropriate according to the embodiment. In another example, the information processing device 1 may perform any information processing on the result of predicting the free time 6. In this case, outputting the information 7 related to the result of predicting the free time 6 may be achieved by outputting the result of such information processing together with, or instead of, the result of predicting the free time 6.

The information processing to be performed on the result of predicting the free time 6 may be selected as appropriate according to the embodiment. In one example, the information processing device 1 may generate proposal information suggesting that a new plan be scheduled in the free time 6. In this case, outputting the information 7 related to the result of predicting the free time 6 may be achieved by outputting the above proposal information. The destination to which the information 7 is to be output is not particularly limited and may be selected as appropriate. Typically, the destination may be a terminal used by the user. In one example of the present embodiment, a time period that is highly likely to be actually available is predicted as the free time 6, based on the processing time 5 estimated using the user's processing ability 4. Accordingly, it is possible to reduce the possibility of proposing new plans that overlap with existing plans. In other words, it can be expected that new plans will be proposed for appropriate free time periods.

### Recording of Processing Results

After the completion of a plan, the results of processing for each task 3 may be accumulated in any manner. The results of processing may be added to the processing performance data 8. In one example, the results of processing may be directly recorded by the user. The recording may be performed for the entire plan or for each task 3.

When the results of processing are recorded for the entire plan, the information processing device 1 may calculate the time taken to perform the plan from the start time and end time of the plan recorded by the user. The information processing device 1 may determine the processing time 5 for each task 3 based on the calculated time taken to perform the plan. The method for determining the processing time 5 for each task 3 from the time taken to perform the plan may be selected as appropriate. The information processing device 1 may use the determined processing time 5 for each task 3 as the results of processing. Alternatively, the time taken to perform the plan may be directly recorded by the user. In this case, the information processing device 1 may determine the processing time 5 for each task 3 based on the directly recorded time taken to perform the plan, and use the determined processing time 5 for each task 3 as the results of processing. When the results of processing are recorded for each task 3, the information processing device 1 may use the processing time 5 for each task 3 recorded by the user as the results of processing.

The method for accumulating the results of processing is not limited to the above examples. For example, the time taken by the user to perform the plan may be inferred according to the user's behavior with respect to the predicted free time 6 (such as whether the user added a new plan during the free time 6). The information processing device 1 may determine the processing time 5 for each task 3 based on the time taken by the user to perform the plan.

### 2. Configuration Example

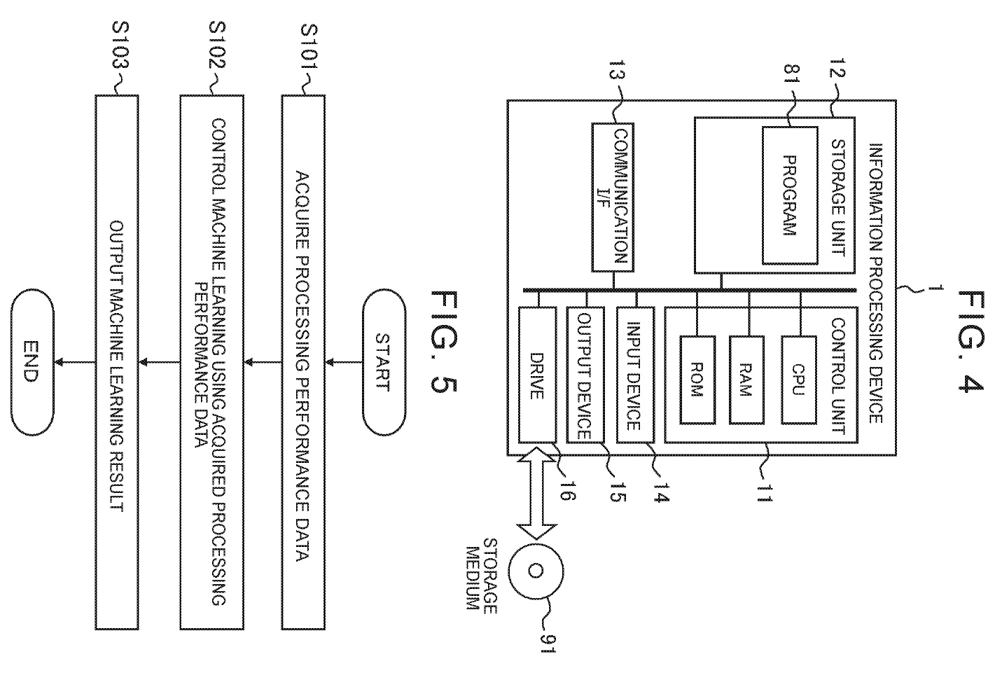

FIG. 4 schematically shows an example of the hardware configuration of the information processing device 1. As shown in FIG. 4, the information processing device 1 according to the present embodiment is a computer in which a control unit 11, a storage unit 12, a communication interface 13, an input device 14, an output device 15, and a drive 16 are electrically connected to each other. The control unit 11 includes a central processing unit (CPU), a random access memory (RAM), a read-only memory (ROM), and the like, and is configured to perform any information processing. The storage unit 12 may be implemented by, for example, a hard disk drive or a solid-state drive. In the present embodiment, the storage unit 12 stores a program 81. The program 81 is a program for causing the information processing device 1 to perform the information processing according to the present embodiment. The program 81 includes a series of instructions for such information processing.

The communication interface 13 is configured to perform data communication, either wired or wireless, via a network. The communication interface 13 may be implemented by, for example, a wired local area network (LAN) module or a wireless LAN module. In the present embodiment, the information processing device 1 may perform data communication with other computers (for example, an external server or a user terminal) via a network using the communication interface 13. The input device 14 is a device for input operations, such as a mouse, keyboard, button, joystick, or control. The output device 15 is a device for output operations, such as a display or speaker. The input device 14 and the output device 15 may be integrated as, for example, a touch panel display.

The drive 16 is a device that reads various kinds of information, such as programs, stored in a storage medium 91. The program 81 may be stored in the storage medium 91 instead of, or in addition to, the storage unit 12. The storage medium 91 is configured to store various kinds of information (such as programs) by electrical, magnetic, optical, mechanical, or chemical action such that a machine such as a computer can read the information. The information processing device 1 may acquire the program 81 from the storage medium 91. The storage medium 91 may be a disk storage medium such as a compact disc (CD) or digital versatile disc (DVD), or a non-disk storage medium such as a semiconductor memory (for example, flash memory). The type of the drive 16 may be selected as appropriate according to the type of the storage medium 91.

The specific hardware configuration of the information processing device 1 may be modified as appropriate depending on the embodiment. Components may be omitted, replaced, or added as appropriate. For example, the control unit 11 may include a plurality of hardware processors. Each hardware processor may be implemented by a microprocessor, a field-programmable gate array (FPGA), a digital signal processor (DSP), a graphics processing unit (GPU), an application-specific integrated circuit (ASIC), or the like.

### 3. Operation Example

An example of the operation of the information processing device 1 according to the present disclosure will be described below. It is assumed that the machine learning model LM is used to estimate the processing time 5 of a task 3. Steps S101 to S103 show a processing procedure for training the machine learning model LM. Steps S201 to S205 show a sequence of processing steps using the trained machine learning model LM until the information 7 related to the free time 6 is output. The following processing procedure is one example of an information processing method executed by a computer.

### Steps S101 to S103

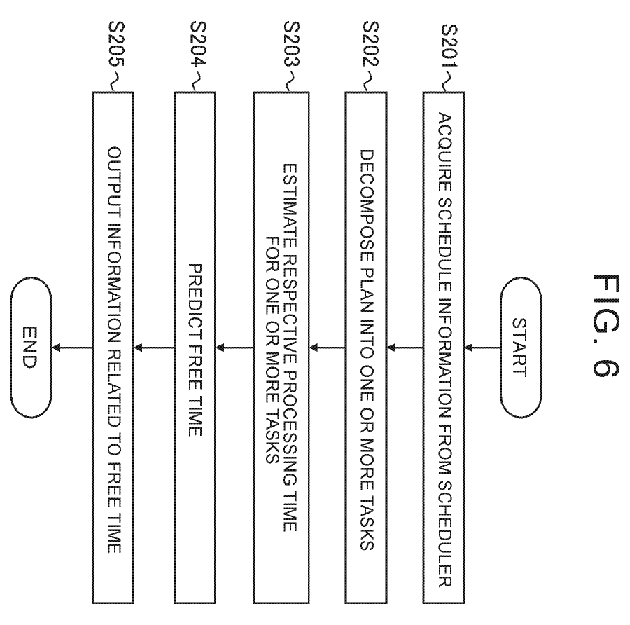

FIG. 5 is a flowchart showing an example of the processing procedure for training the machine learning model LM. In step S101, the control unit 11 acquires the processing performance data 8 related to user's past tasks. The processing performance data 8 may include a plurality of datasets, each including a task and its processing time. In step S102, the control unit 11 controls the machine learning of the machine learning model LM using the acquired processing performance data 8. The machine learning is performed by training the machine learning model LM such that the result of estimating the processing time of a task based on the processing performance data 8 matches a true value indicated by a corresponding correct label. A trained machine learning model LM that has acquired the ability to estimate the processing time 5 from a task 3 can be thus generated. In step S103, the control unit 11 outputs the result of the machine learning performed in step S102. In one example, outputting the result of the machine learning may be achieved by storing, in the storage unit 12, the adjusted values of the computational parameters of the machine learning model LM. When this step is completed, the control unit 11 ends the processing procedure related to the training of the machine learning model LM.

### Steps S201 to S202

FIG. 6 is a flowchart showing an example of a processing procedure executed by the information processing device 1. In step S201, the control unit 11 acquires the schedule information 2 from the scheduler SC. In step S202, the control unit 11 decomposes the user's plan into one or more tasks 3 based on the acquired schedule information 2. In one example, the control unit 11 may decompose the user's plan into one or more tasks 3 in a rule-based manner. In another example, the control unit 11 may decompose the user's plan into one or more tasks 3 by using the trained machine learning model LM.

### Steps S203 to S205

In step S203, the control unit 11 estimates the respective processing time 5 to perform the one or more decomposed tasks 3. In one example, the machine learning model LM trained in steps S101 to S103 may be used for estimating the processing times 5. In step S204, the control unit 11 predicts the user's future free time 6 based on the estimated processing times 5 of the one or more tasks 3. In one example, the control unit 11 may predict the free time 6 by setting a reference time and assuming that the one or more tasks 3 are performed during the time before and/or after the set reference time. In step S205, the control unit 11 outputs the information 7 related to the free time 6. The content of the information 7 to be output and the destination to which the information 7 is to be output may be determined as desired. In one example, the information 7 may include proposal information suggesting that a new plan be scheduled in the free time 6. When this step is completed, the control unit 11 ends the processing procedure.

### 4. Modifications

Although the embodiment of the present disclosure has been described in detail above, the foregoing description is merely illustrative in all respects. It is to be understood that various modifications and variations can be made without departing from the scope of the present disclosure. The processes and means described in the present disclosure may be freely combined and implemented, as long as no technical inconsistency arises.

For example, in the above embodiment, the generation of the trained machine learning model LM may be omitted. Accordingly, in the processing procedure described above, steps S101 to S103 may be omitted. In that case, the information processing device 1 (control unit 11) may estimate, in step S203, the respective processing times 5 to perform the one or more tasks 3 by a method other than using the trained machine learning model LM. For example, the information processing device 1 (control unit 11) may estimate the respective processing time 5 to perform the one or more tasks 3 according to statistical values of the user's past task processing times.

What is claimed is:

1. An information processing device comprising a control unit, wherein the control unit is configured to
acquire schedule information indicating a plan of a user from a scheduler,
decompose the plan indicated by the acquired schedule information into one or more tasks,
estimate respective processing times to perform the one or more tasks according to processing ability of the user for each task, the processing ability being given in advance,
predict free time of the user in a future based on the estimated respective processing times of the one or more tasks, and
output information related to the predicted free time.

2. The information processing device according to claim 1, wherein the processing ability for each task is given in advance according to statistical values of processing times of the user for past tasks.

3. The information processing device according to claim 1, wherein estimating the respective processing times to perform the one or more tasks according to the processing ability for each task is achieved by estimating the respective processing times to perform the one or more tasks by using a trained machine learning model that has acquired an ability to estimate processing time to perform a task based on past task performance of the user.

4. The information processing device according to claim 1, wherein predicting the free time of the user in the future is achieved by either or both of
predicting, as the free time, time after a total of the estimated respective processing times of the one or more tasks has elapsed from a reference time of the plan, and
predicting, as the free time, time between a current time and a point in time calculated by going back from the reference time of the plan by the total of the estimated respective processing times of the one or more tasks.

5. The information processing device according to claim 1, wherein outputting the information related to the free time includes outputting proposal information suggesting that a new plan be scheduled in the free time.
